(19) United States
(12) Patent Application Publication
(10) Pub. No.: US 2026/0326028 A1
(43) Pub. Date: Oct. 22, 2026

(54) CONDENSER-COUPLED PRESSURE SWING ADSORPTION FOR DEHUMIDIFICATION

(71) Applicant: Carrier Corporation, Palm Beach Gardens, FL (US)

(72) Inventor: Dhruv Chanakya Hoysall, Ellington, CT (US)

(21) Appl. No.: 19/447,242

(22) Filed: Jan. 13, 2026

Related U.S. Application Data
(60) Provisional application No. 63/748,222, filed on Jan. 22, 2025.

(51) Int. Cl. B01D 53/26; B01D 53/04; B01D 53/28; F24F 3/14; F25B 25/02

(52) U.S. Cl. CPC B01D 53/261; B01D 53/0438; B01D 53/0446; B01D 53/28; F24F 3/1429; F25B 25/02; B01D 2253/204; B01D 2257/80; B01D 2259/4009; B01D 2259/402; F24F 2003/144

(57) ABSTRACT

A heating, ventilation, air-conditioning and refrigeration (HVAC&R) system is provided. The HVAC&R system includes a condenser, a compressor to output heated fluid toward the condenser, an evaporator, a dehumidification module in which outdoor air is dehumidified prior to entering the evaporator, a fluid loop to support flows of desorption fluid through the dehumidification module and a heat exchanger in which a first portion of the heated fluid increases a thermal energy of the desorption fluid prior to the desorption fluid flowing through the dehumidification module. The increased thermal energy of the desorption fluid is usable for desorption in the dehumidification module.

### CROSS REFERENCE TO A RELATED APPLICATION

The application claims the benefit of U.S. Provisional Application No. 63/748,222 filed Jan. 22, 2025, the contents of which are hereby incorporated in their entirety.

### BACKGROUND

The present disclosure relates to heating, ventilation, air-conditioning and refrigeration (HVAC&R) systems and, more particularly, to condenser-coupled pressure swing adsorption for dehumidification in HVAC&R systems.

A dedicated outdoor air system (DOAS) is a type of heating, ventilation, air-conditioning and refrigeration (HVAC&R) system that includes two or more parallel systems. These include a dedicated system for delivering outdoor air ventilation that handles both the latent and sensible loads of conditioning the ventilation air as well as a parallel system to handle the (mostly sensible heat) loads generated by indoor/process sources and those that pass through the building enclosure.

### BRIEF DESCRIPTION

According to an aspect of the disclosure, a heating, ventilation, air-conditioning and refrigeration (HVAC&R) system is provided. The HVAC&R system includes a condenser, a compressor to output heated fluid toward the condenser, an evaporator, a dehumidification module in which outdoor air is dehumidified prior to entering the evaporator, a fluid loop to support flows of desorption fluid through the dehumidification module and a heat exchanger in which a first portion of the heated fluid increases a thermal energy of the desorption fluid prior to the desorption fluid flowing through the dehumidification module. The increased thermal energy of the desorption fluid is usable for desorption in the dehumidification module.

In accordance with one or more additional and/or alternative embodiments, the condenser, the compressor and the evaporator are components of a vapor-compression cycle which further includes a first line extending from the compressor to the condenser and by which a second portion of the heated fluid travels from the compressor directly to the condenser and a second line extending from the first line to the condenser via the heat exchanger and by which the first portion of the heated fluid flows through the heat exchanger.

In accordance with one or more additional and/or alternative embodiments, at least the desorption fluid includes water.

In accordance with one or more additional and/or alternative embodiments, the first portion of the heated fluid increases a temperature of the desorption fluid to above ambient in the heat exchanger.

In accordance with one or more additional and/or alternative embodiments, the desorption in the dehumidification module is endothermic and the dehumidification module includes a solid desiccant in a metal-organic framework (MOF), which is receptive of the desorption fluid with the increased thermal energy.

In accordance with one or more additional and/or alternative embodiments, the dehumidification module includes first and second adsorption/desorption elements disposed in parallel and respectively including a solid desiccant in a metal-organic framework (MOF), the first and second adsorption/desorption elements are oppositely operable as an adsorption element and as a desorption element, respectively, at a same time and as a desorption element and as an adsorption element, respectively, at a same time, the HVAC&R system further includes a vacuum pulling assembly configured to be coupled to each of the first and second adsorption/desorption elements and the one of the first and second adsorption/desorption elements operating as the desorption element is receptive of the desorption fluid with the increased thermal energy and has a vacuum applied thereto by the vacuum pulling assembly.

According to an aspect of the disclosure, a heating, ventilation, air-conditioning and refrigeration (HVAC&R) system is provided. The HVAC&R system includes a first condenser, a compressor to output heated fluid toward the first condenser, an evaporator, first and second adsorption/desorption elements oppositely operable as an adsorption element, in which outdoor air is dehumidified prior to entering the evaporator, and as a desorption element, a fluid loop to support flows of desorption fluid through one of the first and second adsorption/desorption elements operating as the desorption element and a second condenser in which a first portion of the heated fluid increases a thermal energy of the desorption fluid prior to the desorption fluid flowing through the one of the first and second adsorption/desorption elements. The increased thermal energy of the desorption fluid is usable for desorption in the one of the first and second adsorption/desorption elements.

In accordance with one or more additional and/or alternative embodiments, at least the first condenser, the compressor and the evaporator are components of a vapor-compression cycle which further includes a first line extending from the compressor to the condenser and by which a second portion of the heated fluid travels from the compressor directly to the condenser and a second line extending from the first line to the condenser via the second condenser by which the first portion of the heated fluid flows through the second condenser.

In accordance with one or more additional and/or alternative embodiments, the fluid loop includes a first heat exchanger disposed along the fluid loop in the first adsorption/desorption element, a second heat exchanger disposed along the fluid loop in the second adsorption/desorption element and a pump disposed along the fluid loop and configured to pump the desorption fluid through the one of the first and second heat exchangers associated with the one of the first and second adsorption/desorption elements.

In accordance with one or more additional and/or alternative embodiments, at least the desorption fluid includes water.

In accordance with one or more additional and/or alternative embodiments, the first portion of the heated fluid increases a temperature of the desorption fluid to above ambient in the second condenser.

In accordance with one or more additional and/or alternative embodiments, the desorption in the one of the first and second adsorption/desorption elements is endothermic and each of the first and second adsorption/desorption elements includes a solid desiccant in a metal-organic framework (MOF), which is configured to receive the desorption fluid with the increased thermal energy.

In accordance with one or more additional and/or alternative embodiments, the first and second adsorption/desorption elements are disposed in parallel and each includes a solid desiccant in a metal-organic framework (MOF), the first and second adsorption/desorption elements are oppositely operable as the adsorption element and as the desorption element, respectively, at a same time and as the desorption element and as the adsorption element, respectively, at a same time, the HVAC&R system further includes a vacuum pulling assembly configured to be coupled to each of the first and second adsorption/desorption elements and the one of the first and second adsorption/desorption elements is receptive of the desorption fluid with the increased thermal energy and has a vacuum applied thereto by the vacuum pulling assembly.

According to an aspect of the disclosure, a heating, ventilation, air-conditioning and refrigeration (HVAC&R) system is provided. The HVAC&R system includes a first condenser, a compressor to output heated fluid toward the first condenser, an evaporator, first and second adsorption/desorption elements oppositely operable as an adsorption element, in which outdoor air is dehumidified prior to entering the evaporator, and as a desorption element, a fluid loop to support flows of desorption fluid through one of the first and second adsorption/desorption elements operating as the desorption element and a second condenser receptive of the heated fluid from the first condenser and in which the heated fluid increases a thermal energy of the desorption fluid prior to the desorption fluid flowing through the one of the first and second adsorption/desorption elements. The increased thermal energy of the desorption fluid is usable for desorption in the one of the first and second adsorption/desorption elements.

In accordance with one or more additional and/or alternative embodiments, at least the first condenser, the compressor and the evaporator are components of a vapor-compression cycle.

In accordance with one or more additional and/or alternative embodiments, the fluid loop includes a first heat exchanger disposed along the fluid loop in the first adsorption/desorption element, a second heat exchanger disposed along the fluid loop in the second adsorption/desorption element and a pump disposed along the fluid loop and configured to pump the desorption fluid through the one of the first and second heat exchangers associated with the one of the first and second adsorption/desorption elements.

In accordance with one or more additional and/or alternative embodiments, at least the desorption fluid includes water.

In accordance with one or more additional and/or alternative embodiments, the first portion of the heated fluid increases a temperature of the desorption fluid to above ambient in the second condenser.

In accordance with one or more additional and/or alternative embodiments, the desorption in the one of the first and second adsorption/desorption elements is endothermic and each of the first and second adsorption/desorption elements includes a solid desiccant in a metal-organic framework (MOF), which is configured to receive the desorption fluid with the increased thermal energy.

In accordance with one or more additional and/or alternative embodiments, the first and second adsorption/desorption elements are disposed in parallel and each includes a solid desiccant in a metal-organic framework (MOF), the first and second adsorption/desorption elements are oppositely operable as the adsorption element and as the desorption element, respectively, at a same time and as the desorption element and as the adsorption element, respectively, at a same time, the HVAC&R system further includes a vacuum pulling assembly configured to be coupled to each of the first and second adsorption/desorption elements and the one of the first and second adsorption/desorption elements is receptive of the desorption fluid with the increased thermal energy and has a vacuum applied thereto by the vacuum pulling assembly.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a schematic diagram of a heating, ventilation, air-conditioning and refrigeration (HVAC&R) system with a dehumidification module in accordance with embodiments;

FIG. 2A is a schematic diagram of a heating, ventilation, air-conditioning and refrigeration (HVAC&R) system with a bypass condenser, a first adsorption/desorption element operating as an adsorption element and a second adsorption/desorption element operating as a desorption element in accordance with embodiments;

FIG. 2B is a schematic diagram of a heating, ventilation, air-conditioning and refrigeration (HVAC&R) system with a bypass condenser, a first adsorption/desorption element operating as a desorption element and a second adsorption/desorption element operating as an adsorption element in accordance with embodiments;

FIG. 3A is a schematic diagram of a heating, ventilation, air-conditioning and refrigeration (HVAC&R) system with first and second serial condensers, a first adsorption/desorption element operating as an adsorption element and a second adsorption/desorption element operating as a desorption element in accordance with embodiments; and

FIG. 3B is a schematic diagram of a heating, ventilation, air-conditioning and refrigeration (HVAC&R) system with first and second serial condensers, a first adsorption/desorption element operating as a desorption element and a second adsorption/desorption element operating as an adsorption element in accordance with embodiments.

### DETAILED DESCRIPTION

Currently, rooftop units (RTUs) and DOAS are required to over cool outdoor air to about 55 °F before reheating to 70 °F for dehumidification. This requirement for cooling and reheating can add a significant energy penalty to system performance and can affect system efficiencies. While certain dehumidification systems can be used to address these issues, operations of those dehumidification systems are based on having pressure/vacuum swing adsorption and typically need relatively large amounts of thermal and electrical energy to operate. In particular, due to inefficiencies in conventional systems, up to 50% of available heat is lost to an air stream through an adsorber during the process of adsorption. Typically, the lost heat is made up through a trim heater that is electrically powered, whereby water entering a desorber is heated to the required desorption temperature as desorption is endothermic.

Thus, as will be described below, a dehumidification system for use with an RTU or DOAS in an HVAC&R system is provided and is capable of operations without external thermal energy by focusing on energy recovery from a condenser. This can be done by having an intermediate heat exchanger which will be coupled with refrigerant vapor removed from condenser. For desorption, water is supplied slightly above ambient. With a pressure swing adsorption (PSA) cycle, water entering the desorber needs to only be heated above the ambient and the condenser temperature is high enough to do that. Additionally, this dehumidification system can be installed in hot and humid climates and areas where temperatures tend not to go below freezing, so water can be used safely.

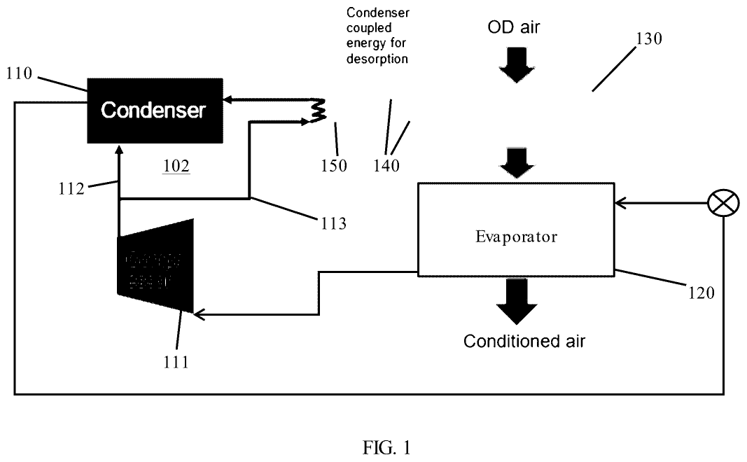

With reference to FIG. 1, an HVAC&R system 101 is provided and can be configured as an RTU/DOAS with an outdoor section and a supply section downstream from the outdoor section. The HVAC&R system 101 can include a vapor-compression cycle 102 with an evaporator 120 and a dehumidification module 130. The vapor-compression cycle 102 includes a condenser 110, a compressor 111 and the evaporator 120. The compressor 111 outputs heated fluid, which has been compressed, toward the condenser 110 for condensing at least a portion of the heated fluid. Condensed fluid output from the condenser 110 flows to the evaporator 120 whereupon the condensed fluid evaporates into vapor. This vapor flows from the evaporator 120 and to the compressor 111 whereupon the vapor is compressed.

The HVAC&R system 101 can be deployed in or on top of a building for conditioning and dehumidifying air entering the building and the vapor-compression cycle 102 and the evaporator 120 can be component(s) of the HVAC&R system 101 (i.e., the vapor-compression cycle 102 and the evaporator 120 may be provided in an outdoor unit of an RTU. Outdoor air can be dehumidified in the dehumidification module 130 prior to entering the evaporator 120.

The HVAC&R system 101 further includes a fluid loop 140 and a heat exchanger 150. The fluid loop 140 is configured to support flows of desorption fluid, such as water or another similar fluid, through the dehumidification module 130 and through the heat exchanger 150.

A first portion of the heated fluid that is output from the compressor 111 and toward the condenser 110 is bypassed away from the condenser 110 and is directed to the heat exchanger 150. Within the heat exchanger 150, a thermal energy of the desorption fluid flowing along the fluid loop 140 is increased prior to the desorption fluid flowing into and through the dehumidification module 130. The increased thermal energy of the desorption fluid is usable for enabling and/or facilitating desorption in the dehumidification module 130 and can manifest and as an increased temperature of the desorption fluid above an ambient temperature of the surroundings by at least some predetermined level.

With the condenser 110, the compressor 111 and the evaporator 120 being components of the vapor-compression cycle 102, the vapor-compression cycle 102 can further include a first line 112 and a second line 113. The first line 112 extends from the compressor 111 to the condenser 110 and a second portion of the heated fluid (i.e., a remainder of the heated fluid output by the compressor 111 less the first portion of the heated fluid) travels along the first line 112 from the compressor 111 directly to the condenser 110. The second line 113 extends from the first line 112 to the condenser 110 via the heat exchanger 150 such that the first portion of the heated fluid flows from the compressor 111, along a section of the first line 112 and along the second line 113 through the heat exchanger 150 and to the condenser 110.

The desorption in the dehumidification module 130 is endothermic and the dehumidification module 130 can include a solid desiccant in a metal-organic framework (MOF), which is receptive of the desorption fluid with the increased thermal energy. In this way, during operations of the HVAC&R system 101, the solid desiccant in the MOF of the dehumidification module 130 acts as an adsorption element that dehumidifies the outdoor air prior to the outdoor air entering the evaporator 120 until it becomes saturated. Following saturation, a vacuum is applied to the dehumidification module 130 and the thermal energy of the desorption fluid flowing along the fluid loop 140 is increased in the heat exchanger 150 whereupon the increased thermal energy of the desorption fluid is usable for enabling and/or facilitating the desorption of the solid desiccant in the MOF in the dehumidification module 130 due to the applied vacuum.

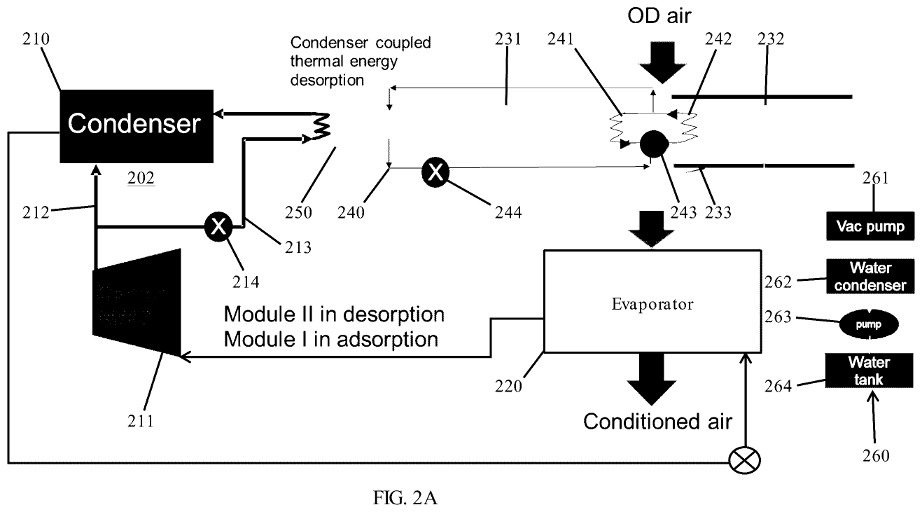

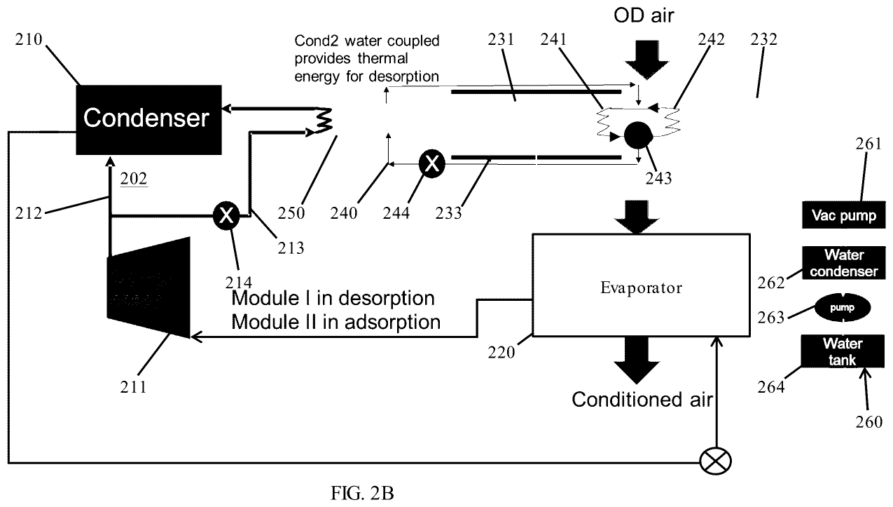

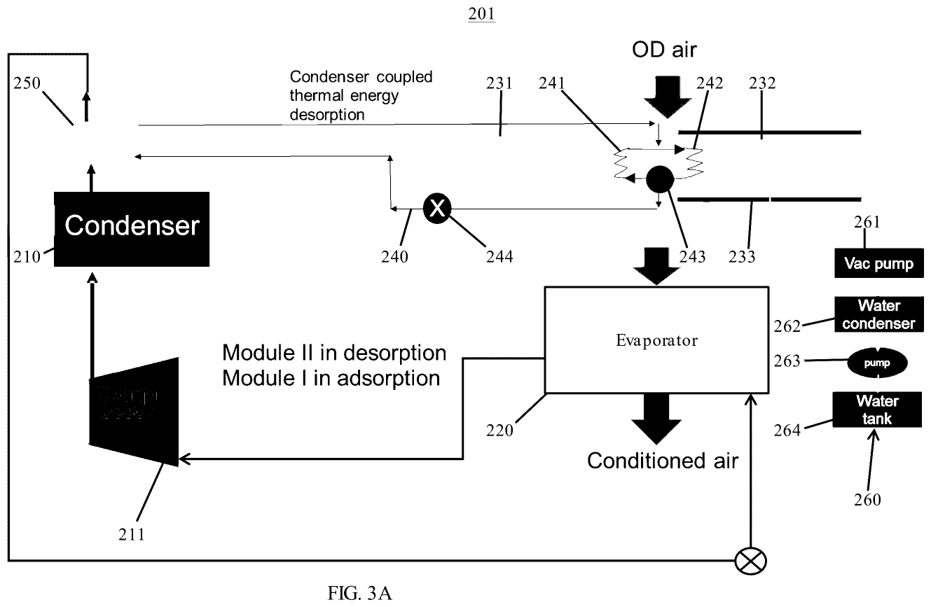

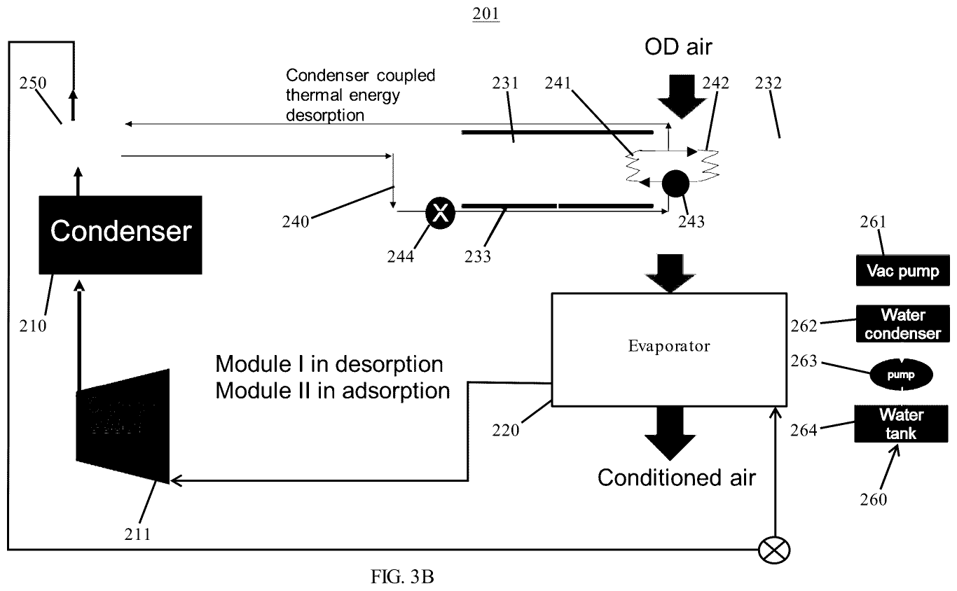

As will be described further below with reference to FIGS. 2A and 2B and with reference to FIGS. 3A and 3B, the dehumidification module 130 of FIG. 1 can include first and second adsorption/desorption elements that are disposed in parallel and that respectively include a solid desiccant in the MOF. In these or other cases, the first and second adsorption/desorption elements are oppositely operable as an adsorption element and as a desorption element, respectively, at a same time and as a desorption element and as an adsorption element, respectively, at a same time. In addition, in these or other cases, the HVAC&R system 101 can further include a vacuum pulling assembly configured to be coupled to each of the first and second adsorption/desorption elements. At any given time, the one of the first and second adsorption/desorption elements that is currently operating as the desorption element is receptive of the desorption fluid with the increased thermal energy and has a vacuum applied thereto by the vacuum pulling assembly.

With reference to FIGS. 2A and 2B, an HVAC&R system 201 is provided and can be configured as an RTU/DOAS with an outdoor section and a supply section downstream from the outdoor section. The HVAC&R system 101 can include a vapor-compression cycle 202 with an evaporator 220 and a parallel arrangement of a first adsorption/desorption element 231 and a second adsorption/desorption element 232. The vapor-compression cycle 202 includes a first condenser 210, a compressor 211 and the evaporator 220. The compressor 211 outputs heated fluid, which has been compressed, toward the first condenser 210 for condensing at least a portion of the heated fluid. Condensed fluid output from the condenser 210 flows to the evaporator 220 whereupon the condensed fluid evaporates into vapor. This vapor flows from the evaporator 220 and to the compressor 211 whereupon the vapor is compressed.

The HVAC&R system 201 can be deployed in or on top of a building for conditioning and dehumidifying air entering the building and the vapor-compression cycle 202 and the evaporator 220 can be a component of the HVAC&R system 201 (i.e., the vapor-compression cycle 202 and the evaporator 220 may be provided in an outdoor unit of an RTU.

Within the parallel arrangement, the first adsorption/desorption element 231 and the second adsorption/desorption element 232 are oppositely operable as an adsorption element, in which outdoor air is dehumidified prior to entering the evaporator 220, and as a desorption element.

As shown in FIG. 2A, the first adsorption/desorption element 231 operates as the adsorption element and the second adsorption/desorption element 232 operates as the desorption element. As shown in FIG. 2B, the first adsorption/desorption element 231 operates as the desorption element and the second adsorption/desorption element 232 operates as the adsorption element. For purposes of clarity and brevity and unless otherwise noted, the following description of the HVAC&R system 201 will relate to the case shown in FIG. 2A.

The HVAC&R system 201 further includes a fluid loop 240 and a second condenser 250. The fluid loop 240 is configured to support flows of desorption fluid, such as water or another similar fluid, through the second adsorption/desorption element 232 and through the second condenser 250. The fluid loop 240 can include a first heat exchanger 241 disposed along the fluid loop 240 in the first adsorption/desorption element 231, a second heat exchanger 242 disposed along the fluid loop 240 in the second adsorption/desorption element 232 and a pump 243. The pump 243 is disposed along the fluid loop 240 and is configured to pump the desorption fluid through the second heat exchanger 242 given its association with the second adsorption/desorption element 232. The fluid loop 240 can further include a control valve 244 configured to control flows of the desorption fluid along the fluid loop 240.

A first portion of the heated fluid output from the compressor 211 and toward the first condenser 210 is bypassed away from the first condenser 210 and is directed to the second condenser 250. Within the second condenser 250, a thermal energy of the desorption fluid flowing along the fluid loop 240 is increased prior to the desorption fluid flowing into and through the second heat exchanger 242 and the second adsorption/desorption element 232. The increased thermal energy of the desorption fluid is usable for enabling and/or facilitating desorption in the second adsorption/desorption element 232 and can manifest and as an increased temperature of the desorption fluid above an ambient temperature of the surroundings by at least some predetermined level.

With the first condenser 210, the compressor 211 and the evaporator 220 being components of the vapor-compression cycle 202 optionally along with the second condenser 250, the vapor-compression cycle 202 can further include a first line 212 and a second line 213. The first line 212 extends from the compressor 211 to the first condenser 210 and a second portion of the heated fluid (i.e., a remainder of the heated fluid output by the compressor 211 less the first portion of the heated fluid) travels along the first line 212 from the compressor 211 directly to the first condenser 210. The second line 213 extends from the first line 212 to the first condenser 210 via the second condenser 250 such that the first portion of the heated fluid flows from the compressor 211, along a section of the first line 212 and along the second line 213 through the second condenser 250 and to the first condenser 210. A control valve 214 can be disposed along the second line 213 and can be configured to control relative amounts of the first and second portions of the heated fluid.

The desorption in the second adsorption/desorption element 232 is an endothermic process that benefits from the increased thermal energy of the desorption fluid. The first and second adsorption/desorption elements 231 and 232 can both include a solid desiccant in a metal-organic framework (MOF), which in both cases is receptive of the desorption fluid with the increased thermal energy. In this way, during operations of the HVAC&R system 201, the solid desiccant in the MOF of the first adsorption/desorption element 231 operates as the adsorption element that dehumidifies the outdoor air prior to the outdoor air entering the evaporated 220 until it becomes saturated while the second adsorption/desorption element 232 operates as the desorption element and regenerates.

The HVAC&R system 201 can further include a vacuum pulling assembly 260, which is configured to be coupled to each of the first adsorption/desorption element 231 and the second adsorption/desorption element 232 and to thereby pull a vacuum with respect to each of the first adsorption/desorption element 231 and the second adsorption/desorption element 232. The vacuum pulling assembly 260 can include a vacuum pump 261, a water condenser 262, a secondary pump 263 and a water tank 264 for water collection in series with one another.

As shown in FIG. 2A, following saturation of the second adsorption/desorption element 232 in a previous cycle, a vacuum seal 233 and a vacuum are applied to the second adsorption/desorption element 232. At the same time, the thermal energy of the desorption fluid flowing along the fluid loop 240 is increased in the second condenser 250. The increased thermal energy of the desorption fluid is usable for enabling and/or facilitating the desorption of the solid desiccant in the MOF in the second adsorption/desorption element 232 by way of the second heat exchanger 242 due to the applied vacuum. As shown in FIG. 2B, once the first adsorption/desorption element 231 becomes saturated and the second adsorption/desorption element 232 is desorbed and regenerated, the flow of the desorption fluid through the fluid loop 240 reverses direction and the vacuum seal 233 and the vacuum are applied to the first adsorption/desorption element 232. At this point, the first adsorption/desorption element 231 operates as the desorption element and the second adsorption/desorption element 232 operates as the adsorption element.

With reference to FIGS. 3A and 3B, the HVAC&R system 201 is provided in a second configuration in which the compressor 211, the first condenser 210 and the second condenser 250 are arranged in series. It will be apparent to one of ordinary skill in the art that the embodiments of FIGS. 3A and 3B are otherwise similar to the embodiments of FIGS. 2A and 2B and a detailed description thereof is not necessary.

It is to be understood that the lengths of time for the adsorption and desorption operations described above may generally be similar to one another and between about 5-30 minutes, depending on the surrounding environment with more humid climates needing shorter cycles and more temperate climates needing longer cycles. It is to be further understood that, in some cases, the cycle times may differ as well. In these or other cases, the operations of the fluid loop 140, 240 can be adjusted accordingly. For example, some cases may arise in which the first and second adsorption/desorption elements 231, 232 are both operated in the adsorption mode at the same time and/or in the desorption mode at the same time (i.e., where the fluid loop 140, 240 delivers desorption fluid with the increased temperature to both the first and second adsorption/desorption elements 231, 232 being operated in the desorption mode at the same time).

Technical effects and benefits of the present disclosure are the provision of a dehumidification system that uses heat from a compressor to enable desorption and thus offers substantial energy savings while being relatively easily integrated into existing HVAC&R systems. In particular, the dehumidification system can provide around a 76% increase in DOAS performance and around 60% higher performance than a DOAS system with a desiccant wheel. The dehumidification system can also allow for smaller condensers and evaporators, which will have lower loads applied thereto.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A heating, ventilation, air-conditioning and refrigeration (HVAC&R) system, comprising:
a condenser;
a compressor to output heated fluid toward the condenser;
an evaporator;
a dehumidification module in which outdoor air is dehumidified prior to entering the evaporator;
a fluid loop to support flows of desorption fluid through the dehumidification module; and
a heat exchanger in which a first portion of the heated fluid increases a thermal energy of the desorption fluid prior to the desorption fluid flowing through the dehumidification module,
the increased thermal energy of the desorption fluid being usable for desorption in the dehumidification module.

2. The HVAC&R system according to claim 1, wherein the condenser, the compressor and the evaporator are components of a vapor-compression cycle which further comprises:
a first line extending from the compressor to the condenser and by which a second portion of the heated fluid travels from the compressor directly to the condenser; and
a second line extending from the first line to the condenser via the heat exchanger and by which the first portion of the heated fluid flows through the heat exchanger.

3. The HVAC&R system according to claim 1, wherein at least the desorption fluid comprises water.

4. The HVAC&R system according to claim 1, wherein the first portion of the heated fluid increases a temperature of the desorption fluid to above ambient in the heat exchanger.

5. The HVAC&R system according to claim 1, wherein:
the desorption in the dehumidification module is endothermic, and
the dehumidification module comprises a solid desiccant in a metal-organic framework (MOF), which is receptive of the desorption fluid with the increased thermal energy.

6. The HVAC&R system according to claim 1, wherein:
the dehumidification module comprises first and second adsorption/desorption elements disposed in parallel and respectively comprising a solid desiccant in a metal organic framework (MOF),
the first and second adsorption/desorption elements are oppositely operable as an adsorption element and as a desorption element, respectively, at a same time and as a desorption element and as an adsorption element, respectively, at a same time,
the HVAC&R system further comprises a vacuum pulling assembly configured to be coupled to each of the first and second adsorption/desorption elements, and
the one of the first and second adsorption/desorption elements operating as the desorption element is receptive of the desorption fluid with the increased thermal energy and has a vacuum applied thereto by the vacuum pulling assembly.

7. A heating, ventilation, air-conditioning and refrigeration (HVAC&R) system, comprising:
a first condenser;
a compressor to output heated fluid toward the first condenser;
an evaporator;
first and second adsorption/desorption elements oppositely operable as an adsorption element, in which outdoor air is dehumidified prior to entering the evaporator, and as a desorption element;
a fluid loop to support flows of desorption fluid through one of the first and second adsorption/desorption elements operating as the desorption element; and
a second condenser in which a first portion of the heated fluid increases a thermal energy of the desorption fluid prior to the desorption fluid flowing through the one of the first and second adsorption/desorption elements,
the increased thermal energy of the desorption fluid being usable for desorption in the one of the first and second adsorption/desorption elements.

8. The HVAC&R system according to claim 7, wherein at least the first condenser, the compressor and the evaporator are components of a vapor-compression cycle which further comprises:
a first line extending from the compressor to the condenser and by which a second portion of the heated fluid travels from the compressor directly to the condenser; and
a second line extending from the first line to the condenser via the second condenser by which the first portion of the heated fluid flows through the second condenser.

9. The HVAC&R system according to claim 7, wherein the fluid loop comprises:
a first heat exchanger disposed along the fluid loop in the first adsorption/desorption element;
a second heat exchanger disposed along the fluid loop in the second adsorption/desorption element; and
a pump disposed along the fluid loop and configured to pump the desorption fluid through the one of the first and second heat exchangers associated with the one of the first and second adsorption/desorption elements.

10. The HVAC&R system according to claim 7, wherein at least the desorption fluid comprises water.

11. The HVAC&R system according to claim 7, wherein the first portion of the heated fluid increases a temperature of the desorption fluid to above ambient in the second condenser.

12. The HVAC&R system according to claim 7, wherein:
the desorption in the one of the first and second adsorption/desorption elements is endothermic, and
each of the first and second adsorption/desorption elements comprises a solid desiccant in a metal-organic framework (MOF), which is configured to receive the desorption fluid with the increased thermal energy.

13. The HVAC&R system according to claim 7, wherein:
the first and second adsorption/desorption elements are disposed in parallel and each comprises a solid desiccant in a metal-organic framework (MOF),
the first and second adsorption/desorption elements are oppositely operable as the adsorption element and as the desorption element, respectively, at a same time and as the desorption element and as the adsorption element, respectively, at a same time,
the HVAC&R system further comprises a vacuum pulling assembly configured to be coupled to each of the first and second adsorption/desorption elements, and
the one of the first and second adsorption/desorption elements is receptive of the desorption fluid with the increased thermal energy and has a vacuum applied thereto by the vacuum pulling assembly.

14. A heating, ventilation, air-conditioning and refrigeration (HVAC&R) system, comprising:
a first condenser;
a compressor to output heated fluid toward the first condenser;
an evaporator;
first and second adsorption/desorption elements oppositely operable as an adsorption element, in which outdoor air is dehumidified prior to entering the evaporator, and as a desorption element;
a fluid loop to support flows of desorption fluid through one of the first and second adsorption/desorption elements operating as the desorption element; and
a second condenser receptive of the heated fluid from the first condenser and in which the heated fluid increases a thermal energy of the desorption fluid prior to the desorption fluid flowing through the one of the first and second adsorption/desorption elements,
the increased thermal energy of the desorption fluid being usable for desorption in the one of the first and second adsorption/desorption elements.

15. The HVAC&R system according to claim 14, wherein at least the first condenser, the compressor and the evaporator are components of a vapor-compression cycle.

16. The HVAC&R system according to claim 14, wherein the fluid loop comprises:
a first heat exchanger disposed along the fluid loop in the first adsorption/desorption element;
a second heat exchanger disposed along the fluid loop in the second adsorption/desorption element; and
a pump disposed along the fluid loop and configured to pump the desorption fluid through the one of the first and second heat exchangers associated with the one of the first and second adsorption/desorption elements.

17. The HVAC&R system according to claim 14, wherein at least the desorption fluid comprises water.

18. The HVAC&R system according to claim 14, wherein the first portion of the heated fluid increases a temperature of the desorption fluid to above ambient in the second condenser.

19. The HVAC&R system according to claim 14, wherein:
the desorption in the one of the first and second adsorption/desorption elements is endothermic, and
each of the first and second adsorption/desorption elements comprises a solid desiccant in a metal-organic framework (MOF), which is configured to receive the desorption fluid with the increased thermal energy.

20. The HVAC&R system according to claim 14, wherein:
the first and second adsorption/desorption elements are disposed in parallel and each comprises a solid desiccant in a metal-organic framework (MOF),
the first and second adsorption/desorption elements are oppositely operable as the adsorption element and as the desorption element, respectively, at a same time and as the desorption element and as the adsorption element, respectively, at a same time,
the HVAC&R system further comprises a vacuum pulling assembly configured to be coupled to each of the first and second adsorption/desorption elements, and
the one of the first and second adsorption/desorption elements is receptive of the desorption fluid with the increased thermal energy and has a vacuum applied thereto by the vacuum pulling assembly.
